(19) United States
(12) Patent Application Publication
(10) Pub. No.: US 2004/0129836 A1
(43) Pub. Date: Jul. 8, 2004

(54) LIQUID HYDROGEN FUELED AIRCRAFT

(75) Inventor: Gerhard E. Seidel, Renton, WA (US)

Correspondence Address: ARTZ & ARTZ, P.C., 28333 TELEGRAPH RD., SUITE 250, SOUTHFIELD, MI, 48034, US

(73) Assignee: THE BOEING COMPANY, Chicago, IL (US)

(21) Appl. No.: 10/605,142

(22) Filed: Sep. 10, 2003

Related U.S. Application Data
(60) Provisional application No. 60/409,770, filed on Sep. 10, 2002.

(51) Int. Cl. B64C 1/00

(52) U.S. Cl. 244/120

(57) ABSTRACT

An aircraft powered with a non-hydrocarbon based fuel source, such as liquid hydrogen. The fuselage contains two elongated cylindrical-type sections positioned side-by-side and joined firmly together. One of the sections houses at least one fuel tank, while the other section can be used to transport passengers, freight and the like.

### CROSS REFERENCE TO RELATED APPLICATIONS

This application claims priority from U.S. Provisional Patent Application Serial No. 60/409,770 filed on Sep. 10, 2002.

### BACKGROUND OF INVENTION

The present invention relates to aircraft and more particular to aircraft which use a non-hydrocarbon based material, such as liquid hydrogen, for the fuel.

The commercial airplane designer is faced with the challenge of balancing many factors to achieve an optimal airplane design, namely, how to reduce jet fuel use while also maintaining or improving emissions, noise, cruise speed, operating cost, range, reliability, maintainability, payload, takeoff field length, initial cruse altitude, and landing speed. Often, fuel efficiency improvements run counter to other design constraints imposed on the aircraft manufacturer by market forces.

Fuel use makes up about 20% of the cash operating cost of a medium commercial airplane. It is in the best interest of the commercial airplane manufacture to reduce fuel use in order to make the airplane more competitive.

It is an object of the present invention to provide an aircraft structure which reduces jet fuel use and at the same time improved emissions and other factors.

### SUMMARY OF INVENTION

The aircraft is powered by a non-hydrocarbon based fuel, such as liquid hydrogen. The liquid hydrogen is placed in longitudinal fuel tanks which are positioned along one side of the passenger cabin. The fuselage has two elongated cylindrical sections positioned side-by-side and covered by the outer skin. One of the cylindrical sections includes the passenger cabins, while the other cylindrical section includes the liquid hydrogen fuel tanks.

The main wing could have a high wing or a low wing configuration. The tail can have two vertical stabilizers joined together by a rear horizontal stabilizer, or be a conventional single vertical stabilizer.

Virtual vision screens could be used in place of the windows, particularly on the side of the passenger cabins adjacent the liquid fuel tanks.

### BRIEF DESCRIPTION OF DRAWINGS

FIG. 1 is a perspective view of an aircraft in accordance with the present invention.

FIGS. 2 and 3, respectively, are top and bottom plan views of an aircraft in accordance with the present invention.

FIG. 4 is a side plan view of an aircraft in accordance with the present invention.

FIGS. 5 and 6, respectively, are front and back views of an aircraft in accordance with the present invention.

FIG. 7 is a cross-sectional view of an aircraft in accordance with the present invention, the cross-section being taken along lines 7-7 in FIG. 2.

FIG. 8 is another embodiment of an aircraft in accordance with the present invention.

### DETAILED DESCRIPTION

The present invention provides a unique aircraft structure which reduces jet fuel usage and at the same time reduces undesirable emissions.

Although the present description discusses the use of liquid hydrogen as the fuel source, any non-hydrocarbon based fuel can be utilized. The use of a non-hydrocarbon based fuel eliminates carbon dioxide emissions. Also, the invention results in reduced nitrous oxide emissions.

Preferably, renewable energy sources (e.g. as wind and solar) or low carbon dioxide producing power plants (e.g. nuclear) are utilized to produce the liquid hydrogen. These have minimal global warming impact.

Liquid hydrogen is relatively light compared to jet fuel, weighing only 36% for the same energy content. The liquid hydrogen fuel, however, takes up over four times the volume of space as Jet-A fuel.

The present invention utilizes current storage vessel technology, such as large pressurized tanks to hold the liquid hydrogen in the aircraft.

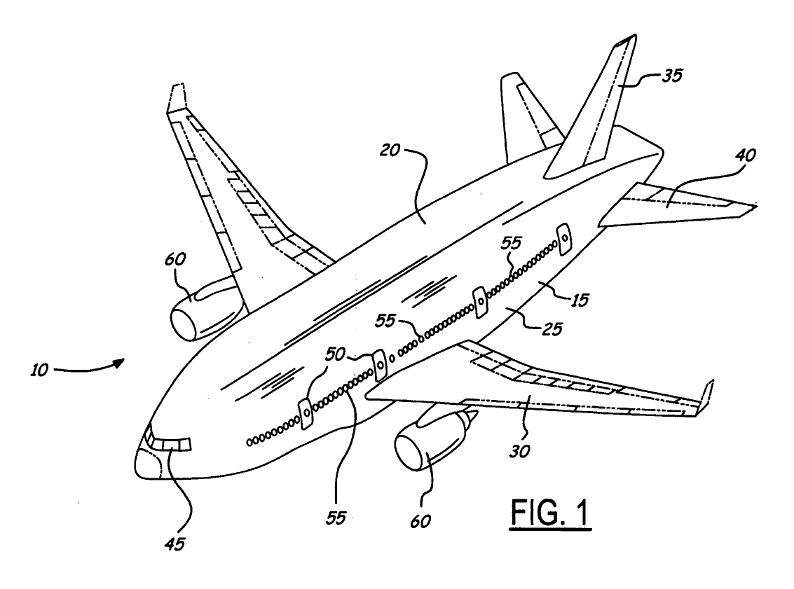

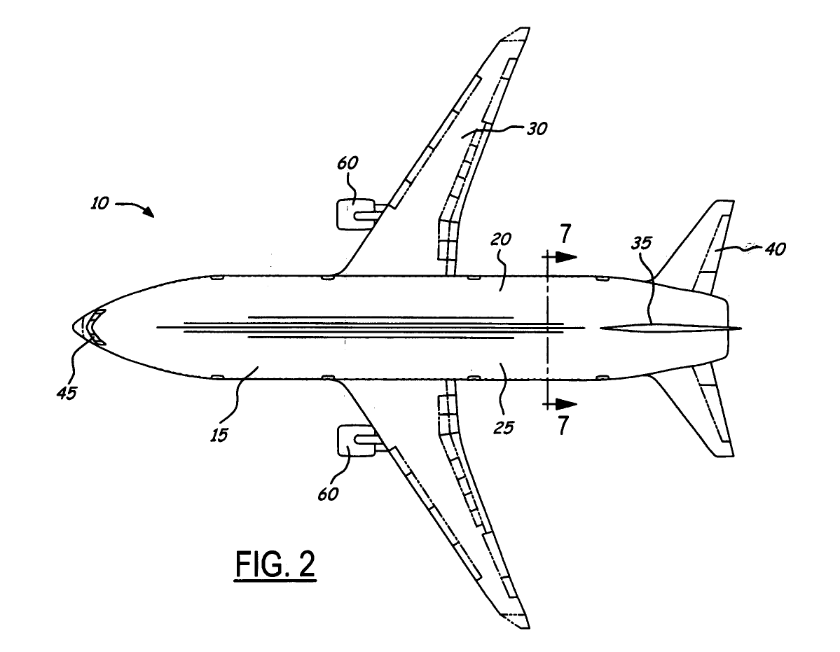

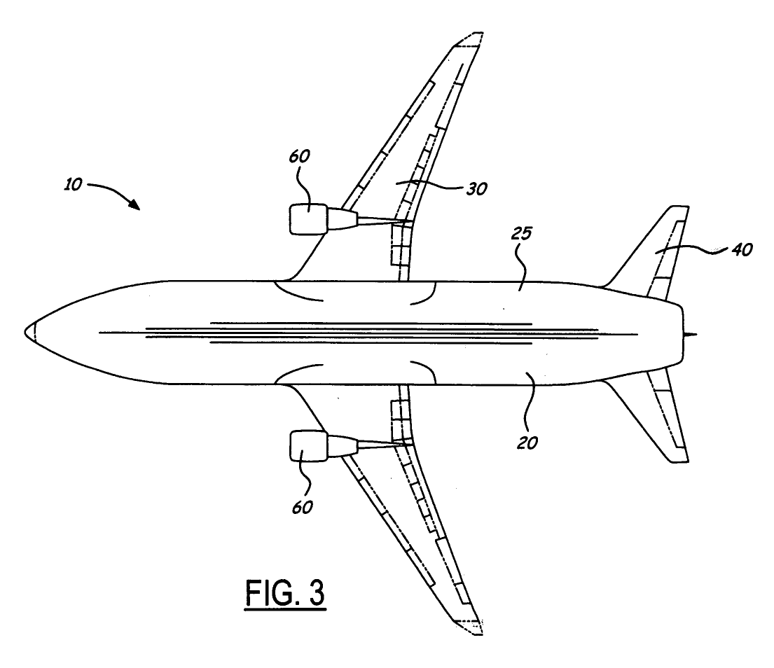

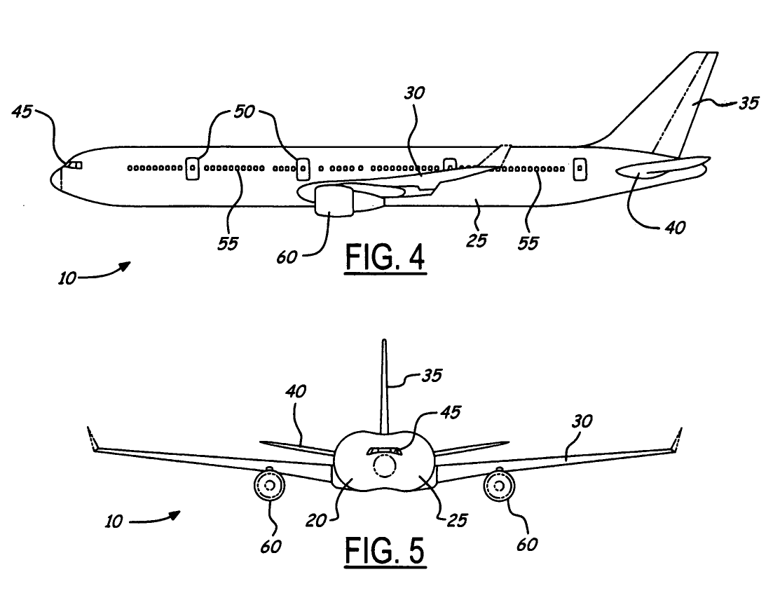

One embodiment of the present invention is depicted in FIGS. 1-7. The inventive aircraft is designated generally by the reference numeral 10.

The aircraft 10 has a main fuselage 15 which has two portions or sections 20 and 25, as discussed below. The aircraft has a main fixed wing 30, a vertical stabilizer (rudder) 35 and a horizontal stabilizer 40. The wing and stabilizer have various flaps and ailerons, as known in the art.

A cockpit 45 is located in the front of the aircraft 10, and a plurality of doors 50 and windows 55 are positioned at least along one side of the fuselage.

A plurality of jet engines 60 are positioned under the main wing 30. In the embodiment 10 shown in FIGS. 1-7, two engines 60 are provided.

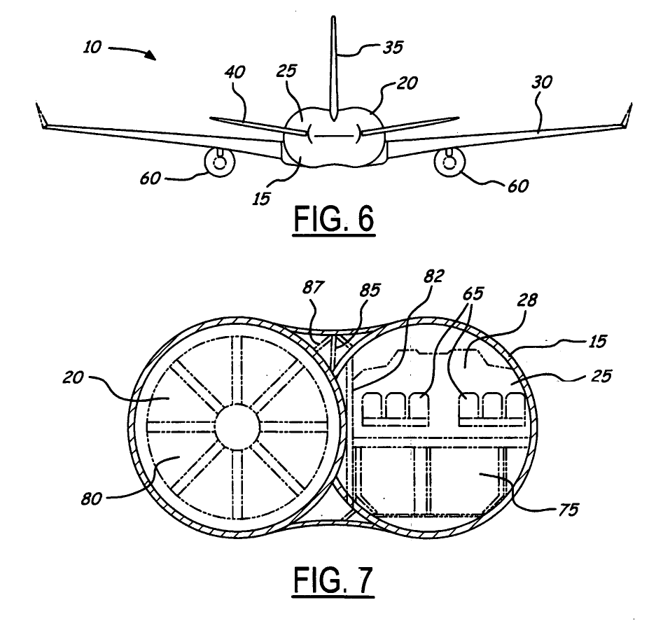

The two sections 20 and 25 of the fuselage 15 are shown in cross-section in FIG. 7. Section 25 is an elongated cylindrical-type structure which houses conventional airline passenger cabins 28. As is known with passenger cabins today, a plurality of rows and sets of passenger seats 64 are positioned on a floor member 70 which is positioned across the width of the cabin. A lower bay 75 is positioned below the floor member and is used to hold luggage, packages and the like as is conventional with aircraft today.

It is also understood that section 25 could also be used entirely for storing, holding, or transporting freight-type goods and packages. In this instance, the seats 65 preferably are removed in order to open up more space for freight.

Section 20 also is an elongated cylindrical-type structure and houses one or more fuel tanks 80. Preferably, the tank or tanks are pressurized vessels and are filled with liquid hydrogen which is used as the fuel for the aircraft.

The two sections 20 and 25 are firmly affixed together by appropriate structure fastening members, such as beam members 85 and 87. Also, due to the structure of the fuel tanks 80, the side 82 of the passenger cabin section 25 adjacent the fuel tanks is modified to accommodate the fuel tanks and full cylindrical configuration of section 25.

Since one side of the passenger cabin (i.e. the side adjacent the fuel tank section) will not have windows, other sources and mechanisms can be utilized. These include video screens, virtual vision screens, or the like.

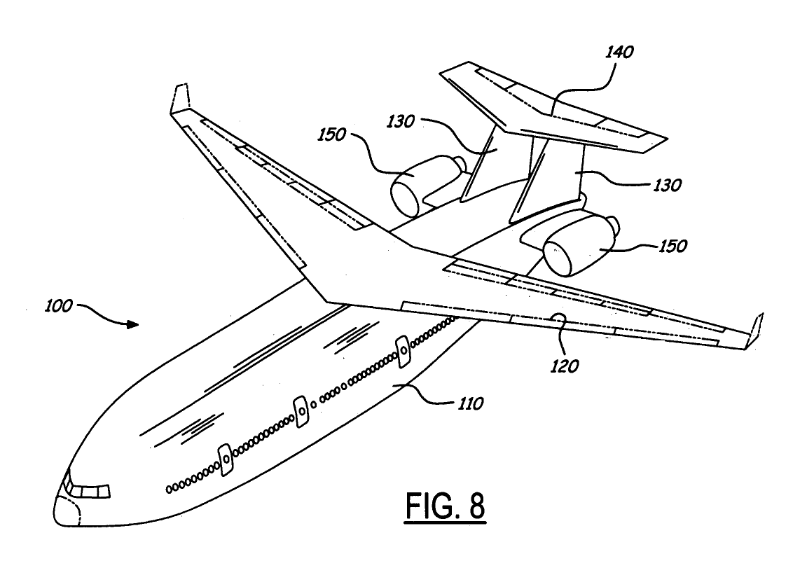

FIG. 8 depicts another embodiment of the present invention. The aircraft is designated generally by the reference numeral 100. The aircraft 100 has a high main wing 120 attached to the fuselage 110. Two vertical stabilizers (rudders) 130 are positioned adjacent the rear of the fuselage and a horizontal stabilizer 140 is attached to the vertical stabilizers.

A pair of jet engines 150 are positioned adjacent the rear of the fuselage and are used to power the aircraft. The fuselage 110 has the same two-section structure as described above with reference to FIGS. 1-7. The fuselage has side-by-side cylindrical sections firmly joined together and covered by the outer skin of the aircraft. One of the sections houses the fuel tanks while the other section is used to transport passengers or freight, or both.

While the invention has been described in connection with one or more embodiments, it is to be understood that the specific mechanisms, processes and procedures which have been described are merely illustrative of the principles of the invention, numerous modifications may be made to the methods and apparatus described without departing from the spirit and scope of the invention as defined by the appended claims.

1. An aircraft comprising a fuselage, a main wing, at least one vertical stabilizer and at least one horizontal stabilizer, said fuselage comprising two elongated substantially cylindrical sections joined together side-by-side, one of said sections having at least one fuel tank positioned therein.

2. The aircraft as described in claim 1 wherein the other of said sections has at least one passenger cabin therein.

3. The aircraft as described in claim 1 wherein the fuel tank is used to hold liquid hydrogen as the fuel for the aircraft.

4. The aircraft as described in claim 1 wherein a plurality of fuel tanks are provided in said section.

5. The aircraft as described in claim 1 wherein two of said vertical stabilizers are provided.

6. The aircraft as described in claim 1 wherein said main wing is positioned on top of said fuselage.

7. The aircraft as described in claim 1 wherein said fuel tank is used to hold a non-hydrocarbon based fuel.
